(19) United States
(12) Patent Application Publication
(10) Pub. No.: US 2006/0072756 A1
(43) Pub. Date: Apr. 6, 2006

(54) Computer-based vehicle reservation system and method for a computer-based vehicle reservation system

(75) Inventors: Urs Leimgruber, Belp (CH); Hans A. Ulrich, Muenchenbuchsee (CH); Christoph G. Kamber, Grenchen (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: Swisscom AG, Bern 29 (CH)

(21) Appl. No.: 10/528,096

(22) PCT Filed: Sep. 16, 2003
(86) PCT No.: PCT/CH03/00626

§ 371 Date: Mar. 16, 2005

(30) Foreign Application Priority Data
Sep. 16, 2002 (EP) 02405805.9

(51) Int. Cl. H04K 1/00

(52) U.S. Cl. 380/270

(57) ABSTRACT

A computer-based vehicle reservation system and a method for a computer-based vehicle reservation system. According to the method: the availability of all vehicles in the vehicle reservation system is detected; a user reserves a vehicle for a determinable time and/or period and/or location by a computing unit connected to a central unit; an identification code is transmitted to a mobile radio device of the user by an SMS module of a central unit; the user is identified in an identification module by the identification code; and the vehicle is released for use. In particular, the billing process for the related services can be automated by the method and system.

The present invention relates to a computer-supported vehicle reservation system as well as to a method for a computer-supported vehicle reservation system in which a user identifies himself at an identification module, the identification module checks the identification with a central unit, and, with successful identification of the user, the vehicle is cleared for use via an onboard system of the vehicle.

There exist many known hiring agencies today for hiring automobiles or various other vehicles. The hiring takes place usually at transfer and receiving points of the hiring agent where the customer can hire a vehicle and can obtain the hired vehicle. The procedure of automobile hiring today absolutely still necessitates the allocation of a vehicle for an earmarked customer since the hiring agent would like to hire out as many of his vehicles as possible, i.e. would like to operate his vehicle fleet at capacity in an optimal way. The reservations necessary therefor are carried out by company-specific booking centres. If vehicles are still freely available at a hiring station or respectively at a transfer and receiving point with attached vehicle fleet, such as e.g. at airports, these can also be hired directly on site. After use of the vehicle or respectively after expiration of the agreed-upon hiring period, the customer must also give the vehicle back again at one of the transfer and receiving points of the hiring agent. The hiring period for a vehicle amounts typically to from some days to some weeks. Among the formalities are, for example, the filling out of forms with customer-specific data, such as e.g. ID number of the driver's license, validity and period of validity of the driver's license, address, birth date, credit card numbers, etc. Among the drawbacks of the state of the art are, among others, that the point of return usually has to be established already when hiring the vehicle. Another drawback is the relatively high investment in time, personnel and costs, which has to be made for the hiring agency. Described in the U.S. Pat. Nos. 5,289,369 and 5,124,920 are systems permitting a semi-automation of automobile hiring. In these systems the vehicles can each be equipped with a position determination, such as e.g. a GPS (Global Positioning System), which transmits position data for the available vehicles via radio to an administration unit. In these systems the vehicles can be additionally equipped with an identification module with which authorisation data, which are stored on a chipcard, such as e.g. a smart card, can be checked, and, in the case of corresponding data, the vehicle cleared for use. Although the last-mentioned prior art solves some of the problems in a rudimentary way, the mentioned drawbacks essentially remain. A semi-automation of the hiring does result through these systems; nevertheless the outlay with respect to costs and personnel for the hiring agent is still considerable. This way the hiring formalities must continue to be carried out by the hiring agent together with the customer. In the case of identification by means of chipcards, the hiring formalities additionally include the handover of such cards. The chipcards have furthermore the drawback that the costs for the cards must be borne by the hiring agent since otherwise he is not able to compete with other hiring systems. The chipcards must also be administered by the hiring agent, and, as said, distributed to the customers. In other respects the chipcards have the disadvantage that they must be brought along by customers if the customer wants to obtain the vehicle. This not only calls for an additional effort on the part of the customer, it results in further drawbacks. This way the security can easily be circumvented with fraudulent intent by a third party if the customer loses the chipcard, for instance, or the chipcard otherwise gets out of his hands. Depending upon application, the protection against misuse by third parties can be insufficient with the system. A further disadvantage of this prior art is that with the hiring formalities the payment, such as e.g. the mode of payment, must also be arranged by the hiring agent. The patent publication FR 2 801 994 discloses a method and a system for administration of vehicles for a multiplicity of users. In the method a user identifies himself at a central unit by means of mobile radio device, and is localised by the central unit based on the location of the mobile radio device. By means of a database, the central unit checks the availability of vehicles at the location of the user, and releases a particular vehicle for use by the user. The patent publication U.S. 2002/0099574 A1 shows another solution of the state of the art. In the method for electronic reservation of a parking space for a vehicle, the driver of a vehicle uses the keyboard of his mobile telephone in order to send a parking space query electronically to a parking space reservation computer.

It is an object of this invention to propose a new vehicle reservation system as well as a method for a vehicle reservation system not having the above-described drawbacks. In particular, the hiring method should offer the possibility of an automatic billing, and a high level of security against misuse and fraud should be ensured, the fleet of vehicles being utilized in an optimal way.

According to the present invention, these objects are attained in particular by the elements of the independent claims. Further advantageous embodiments will come out of the independent claims and the specification.

In particular these objects are achieved in that a user identifies himself at an identification module, the identification module checks the identification with a central unit, and, with successful identification of the user, the vehicle is cleared for use via an onboard system of the vehicle, the central unit registering all vehicles of the vehicle reservation system, and storing, assigned to the vehicles, in a database temporal and/or local availability of the individual vehicles, the user identifying himself at the central unit via the input elements of a computing unit connected to the central unit, and reserving a vehicle for a definable time and/or time span and/or location, which vehicle is indicated by the central unit as available for the definable time and/or time span and/or location, an SMS module of the central unit transmitting an identification code to a mobile radio device of the user by means of an SMS over a mobile radio network, and the user identifying himself at the definable time and/or location at the identification module by means of the identification code of the SMS, based on which identification the vehicle is cleared for use. The above-mentioned embodiment has the advantage that a high level of security against misuse and/or fraud can be ensured through the combination of the order with an identification code via an independent feedback channel with high security mechanisms. In particular, the system is very user-friendly, both on the side of the user (customer) as well as on the side of the hiring agent, since it requires no further installations other than those already available. Thus the user does not have to carry around any additional cards, among other things. Through the protection mechanisms (e.g. registration with a PIN code) usually present in a mobile radio device, the identification code is correspondingly protected. The risk of loss or theft of the chipcard does not exist. For the hiring agent the system has the advantage that he does not need e.g. chipcards with the corresponding costs. At the same time he does not have to administrate the chipcards or similar identification means, which reduces the investment in personnel. The identification of the customer is completely ensured e.g. based on the MSISDN (Mobile Subscriber ISDN) and/or IMSL (International Mobile Subscriber Identification). Further advantages are also that the administration of the vehicles is fully automated without the hiring agent having to prepare the vehicle himself or the customer e.g. having to establish beforehand the return location.

In an embodiment variant, a reply SMS containing at least the identification code is sent back for confirmation by the mobile radio device over the mobile radio network to the central unit, by means of which reply SMS the user is identified by the identification module, and by means of which central unit the vehicle is cleared for use for the defined time and/or duration and/or place. This embodiment variant has the advantage, among others, that the security against misuse and/or fraud can be further increased through the reciprocal use of the feedback channel with the corresponding security mechanisms.

In a further embodiment variant, the central unit checks the operational condition of the vehicle via the onboard system of the vehicle by means of SMS before release of the vehicle. This embodiment variant has the advantage, among others, that the user can be sure to find a fully operational vehicle at the defined time. Thus, for example, battery condition, oil level, filling of petrol, tyre pressure, coolant level, etc. can be detected by means of the onboard system of the vehicle, and checked beforehand by the central unit. As an embodiment variant, the onboard system can check the operational condition of the vehicle self-sufficiently and/or upon request of the central unit, in particular also periodically, the data of the database of the central unit being thereby updated.

In an embodiment variant, by means of said SMS, the SMS module of the central unit transmits the identification code to the mobile radio device of the user within a specified time period before begin of the desired use. The time period can be e.g. one and a half days before beginning of use or a similar duration. This has the advantage, among others, that not only can the user be reminded about the reservation within a sensible time frame prior to use, but also e.g. the risk can be reduced that the SMS is erased in the meantime by the user e.g. because of lack of storage capacity on the SIM card of the mobile radio device or by mistake.

In a still different embodiment variant the central unit transmits to the user a confirmation of the reservation on the computing unit. This has the advantage, among others, that the user can receive a receipt for his reservation which reminds him about the details of the reservation or respectively about the reservation conditions, and confirms these.

In an embodiment variant, billing data are calculated by means of a billing module of the central unit, and transmitted by means of a communication module of the central unit from the central unit to a service provider of a mobile radio network, which billing data comprise cost parameters for calculating cost amounts for the service obtained by the user through the hired car. This embodiment variant has the advantage, among others, that the user can pay for the obtained services e.g. together with the monthly statement of mobile radio network fees. For the hiring agent a high level of security is ensured without his having to administrate the billing himself and having to carry out the corresponding formalities with data acquisition. This provides a large savings in costs and personnel investment.

In another embodiment variant, the SMS further comprises vehicle designation and/or place and/or point in time and/or time span. This embodiment variant has the advantage, among others, that the user receives together with the identification code a confirmation of the hiring conditions, such as place and/or time and/or duration.

In a further embodiment variant, the vehicle is parked in an access-controlled area, the user identifying himself upon entering the access-controlled area at an identification module by means of the identification code. This embodiment variant has the advantage, among others, that the security against fraud and/or misuse can be further increased.

In still another embodiment variant, the mobile radio device is used as computing unit. This embodiment variant has the advantage, among others, that a user can hire a desired vehicle quickly and in a user-friendly way e.g. by means of SMS and/or GPRS and/or USSD data messages. Through the security mechanisms of the mobile radio network, the user is sufficiently identifiable for the hiring and payment agreements. The identification takes place e.g. via the MSISDN or IMSI assigned to the mobile radio device. As an embodiment variant, the MSISDN or IMSI can be captured by the central unit by means of calling line identification.

In an embodiment variant, the computing unit communicates with the central unit via one or more computer networks. The computer networks can be in particular LANs (Local Area Network), WANs (Wide Area Network), Bluetooth, mobile radio networks, such as a terrestrial mobile radio network, e.g. a GSM (Global System for Mobile Communication) or UMTS network (Universal Mobile Telephone System) and/or one or more fixed networks, e.g. the public switched telephone network (PSTN), in particular however also the worldwide backbone network (Internet). This embodiment variant has the advantage, among others, that the user can carry out the order and reservations at the hiring agent simply, e.g. from his work station or his PC, via Internet or another above-mentioned computer network.

In a further embodiment variant, for identification at the central unit the user indicates the MSISDN or IMSI of the mobile radio device. This embodiment variant has the advantage, among others, that through indication of his MSISDN the user is already completely identifiable, without his having to learn and remember other numerical codes and/or identification numbers. The feedback channel by means of SMS via the mobile radio device thereby permits a high degree of protection against fraud and/or misuse.

In an embodiment variant, the central unit comprises a parking space administration module and/or a parking space reservation module, whereby, during the reservation of the vehicle, indications about a destination being transmitted to the central unit by means of the computing unit and/or the SMS containing indications about a reserved parking space at the destination. This embodiment variant has the advantage, among others, that with the reservation of the vehicle the user can reserve at the same time a safe location for his vehicle at the destination. The risk can also be thereby reduced, for instance, of the vehicles of the vehicle reservation system being damaged through poorly selected parking spaces. At the same time surveillance of the vehicles and/or monitoring of any services rendered during use can also be simplified and made more economical.

It should be stated here that in addition to the method according to the invention, the present invention also relates to a system for carrying out this method.

Embodiment variants of the present invention will be described in the following with reference to examples. The examples of the embodiments are illustrated by the following attached figures:

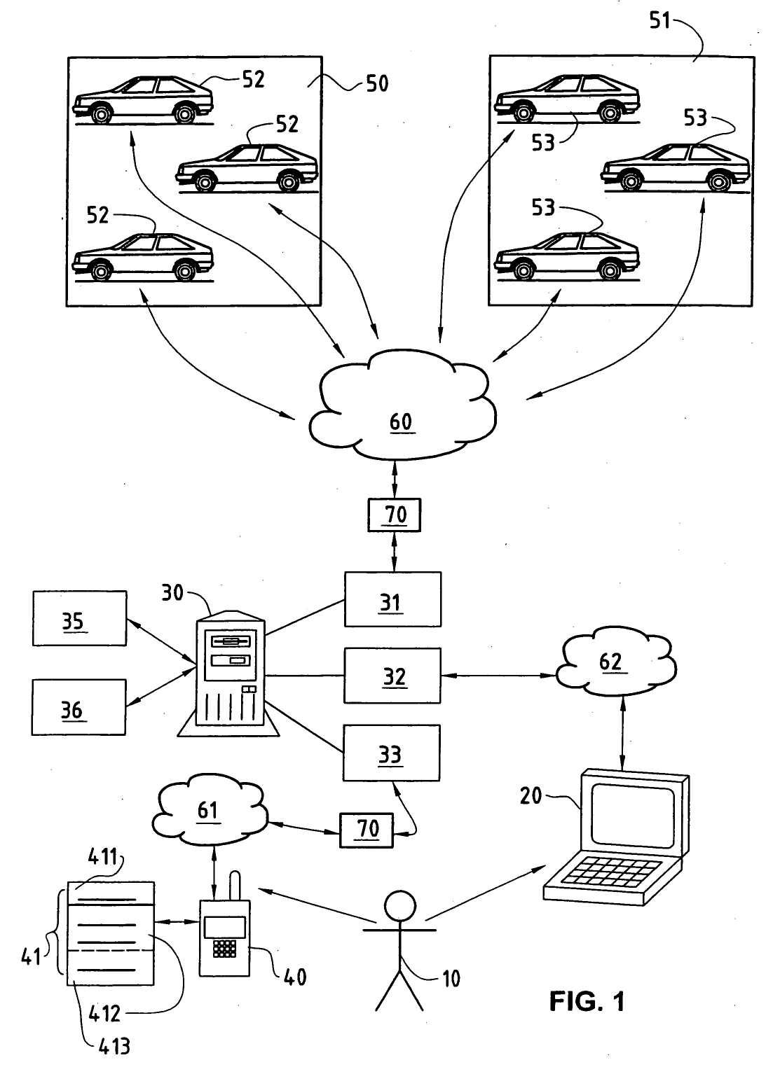

FIG. 1 shows a block diagram representing schematically a computer-supported vehicle reservation system in which a user 10 identifies himself at an identification module, the identification module being connected to a central unit 30/31 via a communication network.

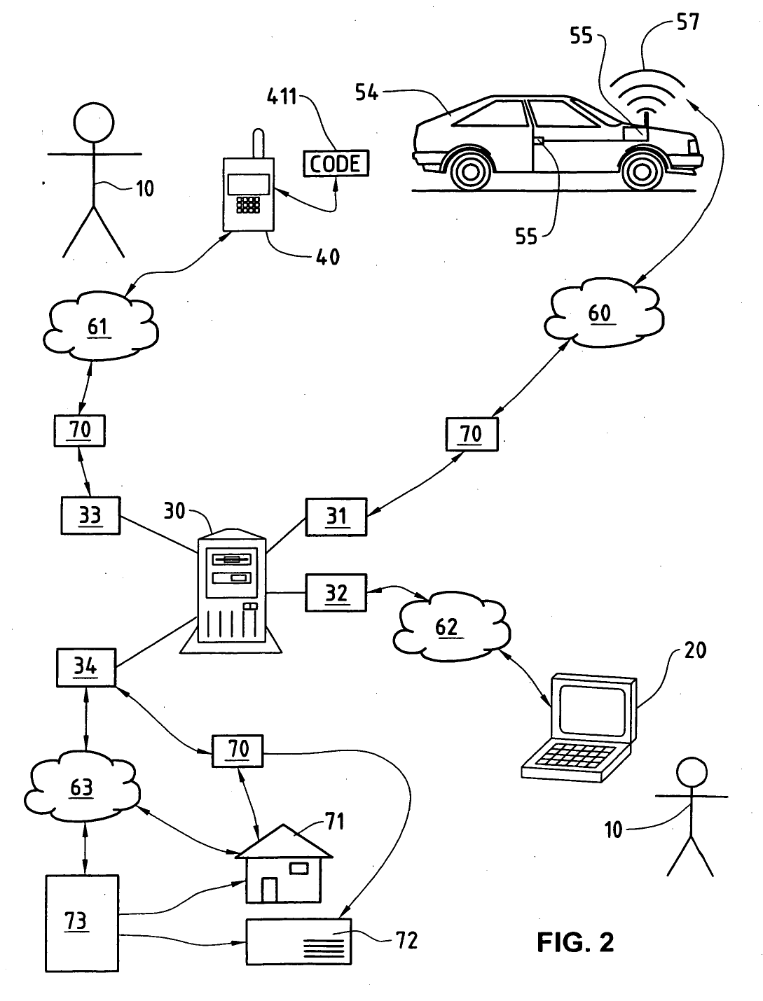

FIG. 2 shows a block diagram, likewise representing schematically a computer-supported vehicle reservation system, in which a user 10 identifies himself at an identification module of a vehicle 52/53, the obtained service being billed for automatically by means of a billing module 34 of the central unit 30 via a service provider 70 of a mobile radio network 63.

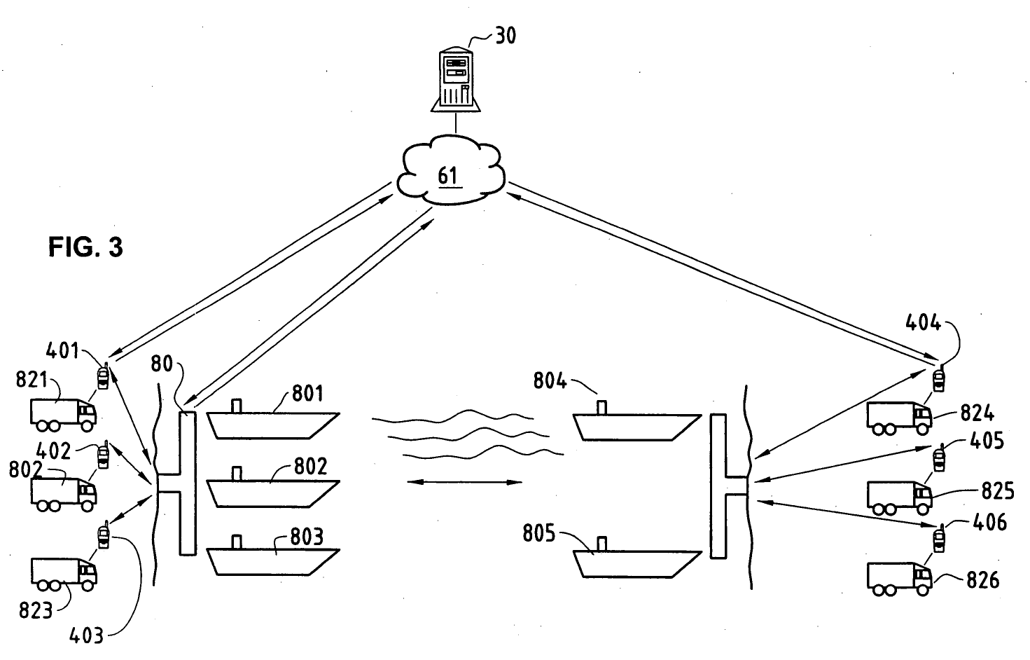

FIGS. 3 to 5 show application examples of the invention in schematical representation. FIG. 3 shows as an example the combined transportation for transportation routes that comprise water sections.

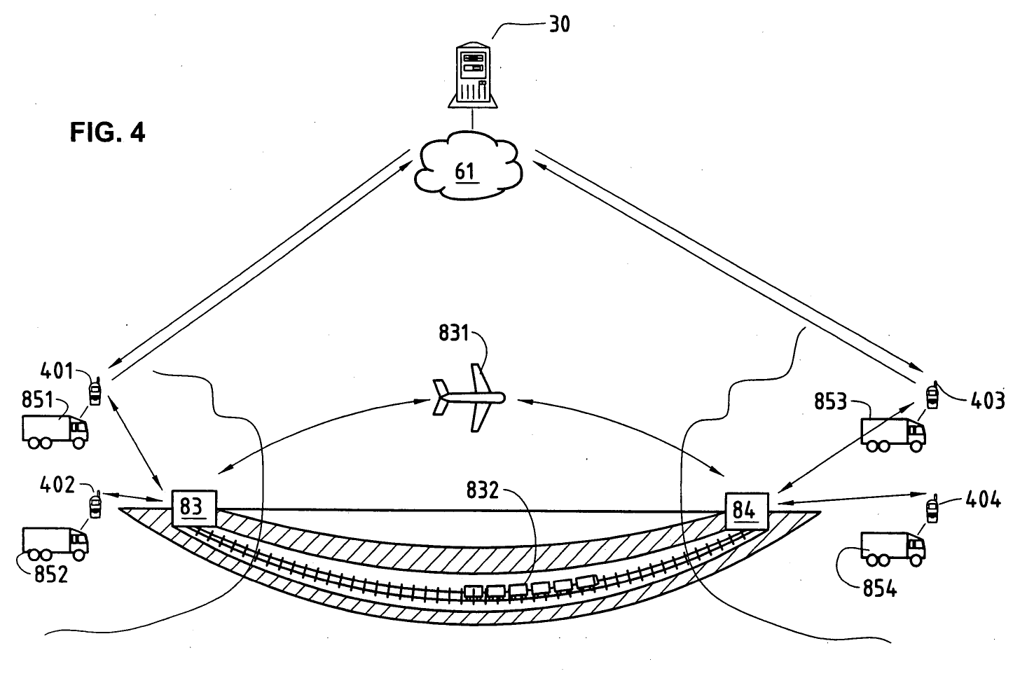

FIG. 4 shows in schematical representation likewise a combined transportation (flight cargo traffic, heavy load train tunnel traffic).

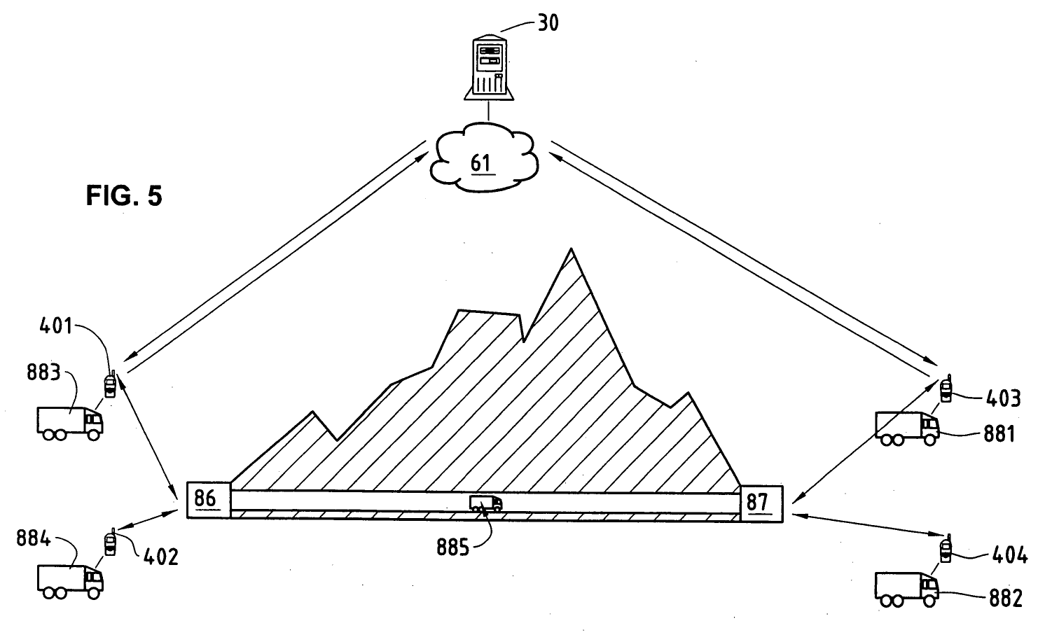

FIG. 5 shows in schematical representation the application of the method and/or the system of the invention for tunnel crossings with limited capacity.

FIG. 1 and FIG. 2 illustrate a computer-supported vehicle reservation system or respectively a method for a computer-supported vehicle reservation system, as can be used in achieving the invention. Same reference numerals in FIGS. 1 and 2 designate same elements. In this embodiment example, a computer-supported central unit 30 registers all vehicles 52/53/54 of the vehicle reservation system, and stores, assigned to the vehicles 52/53/54, temporal and/or local availability of the individual vehicles 52/53/54 in a database of a vehicle fleet administration module 31. The data records of the vehicles can likewise contain data relating to their technical features such as e.g. vehicle type, year, amount of kilometres, maintenance period, oil/petrol level, etc. Hiring agents for the vehicles 52/53/54 can be vehicle hiring companies, such as the well-known Avis, Hertz, Budget, etc., but also company-internal hiring or distribution divisions for vehicles. Of course the invention is not limited to the hiring of vehicles, but relates to hiring and/or rental systems in general. The vehicle fleet of the vehicle reservation system can comprise vehicles 52/53/54 of any type and with any intended use. Each vehicle 52/53/54 comprises communication means 57, by means of which data are transmittable bidirectionally with the central unit 30 via a communication network 60. The communication means 57 are part of an onboard system 55 of each vehicle 52/53/54, which can comprise, among other things, means (such as e.g. corresponding sensors, memory means, etc.) for detecting the operational condition (oil level, coolant level, amount of kilometres, petrol level, battery charge level, etc.) of the vehicle 52/53/54. The communication network 60 can comprise e.g. a mobile radio network, such as a terrestrial mobile radio network, for example a GSM (Global System for Mobile communication) and/or UMTS (Universal Mobile Telephone System) and/or a satellite-based mobile radio network and/or WLAN (Wireless Local Area Network), such as e.g. Bluetooth, one or more fixed networks such as, for example, the public switched telephone network (PSTN), the worldwide Internet, or a suitable LAN (Local Area Network) or WAN (Wide Area Network). The communication via the communication network 60 can take place, for instance, by means of special short messages, e.g. SMS (Short Message Services), EMS (Enhanced Message Services), via a signalling channel, such as e.g. USSD (Unstructured Supplementary Services Data) or other technologies, such as MExE (Mobile Execution Environment), GPRS (Generalized Packet Radio Service), WAP (Wireless Application Protocol) or UMTS (Universal Mobile Telecommunications System) or via a user information channel. The transmission can take place periodically or triggered by a data acquisition module of the vehicle 52/53/54 and/or of the central unit 30. Used as trigger can be e.g. the case where new data are registered and/or data are required e.g. in the central unit for an evaluation. The vehicle 52/53/54 can comprise means for position determination, such as e.g. a GPS module (Global Positioning System). The position of the vehicle can thereby be updated at the central unit 30 anytime via the mobile radio network 60. The position of the vehicle can however also be determined e.g. by means of triangulation methods of the mobile radio network 60, and be updated when needed by the central unit 30. Each vehicle 52/53/54 contains an unambiguous vehicle identification. The vehicle identification for the vehicle 52/53/54 can comprise, for example, an International Mobile Subscriber Identity (IMSI) or an MSISDN (Mobile Subscriber ISDN) which serve the purpose of identification in a mobile radio network, and can be stored, for instance, in a chipcard of the communication means 57, e.g. an SIM card (Subscriber Identification Module). To ensure the operational condition before use, the central unit 30 can check the operational condition of the vehicle 52/53/54 via the onboard system 55 of the vehicle 52/53/54, e.g. by means of SMS, before the clearance for use. It is also possible however for the onboard system 55 to check the operational condition of the vehicle 52/53/54 periodically and/or upon request of the central unit 30, operational condition data for the respective vehicle being updated in the database 31 of the central unit 30. With such a system and method the central unit 30 always has possession of current data relating to the vehicles 52/53/54 of the vehicle reservation system. For reservation, the user 10 identifies himself via the input elements of a computing unit 20 connected to the central unit 30, and reserves a vehicle 52/53/54 for a definable point in time and/or time span and/or place, the vehicles 52/53/54 available for the definable point in time and/or time span and/or place being indicated to the user 10 by the central unit 30 via the computing unit 20. The computing unit 20 can communicate e.g. via one or more computer networks 62 with the central unit 30 or respectively with a parking space reservation module 38 of the central unit 30. The computing unit can be any mobile and/or non-mobile Customer Premise Equipment (CPE), such as e.g. a PDA, mobile radio device such as a mobile radio telephone, laptop, PC (Personal Computer), etc. The download mechanisms to the computing unit can also comprise DAB/MexE applets. The computing unit 20 comprises corresponding physical network interfaces, e.g. interfaces to Ethernet or another wired LAN (Local Area Network), Bluetooth, GSM (Global System for Mobile Communication), GPRS (Generalized Packet Radio Service), USSD (Unstructured Supplementary Services Data), UMTS (Universal Mobile Telecommunications System) and/or WLAN (Wireless Local Area Network), etc. The interfaces through software and/or hardware can comprise e.g. an adapter, which includes a transmitter/receiver as well as control card (such as e.g. Infrared (IR) Adapter or a low frequency radio wave adapter). If mobile systems are used as computing units 20, they can communicate e.g. by means of radio frequency signals with so-called access points (WLANs) or so-called BTS (Base Transceiver Station) (mobile radio networks), for connection to the mentioned networks. Via the interface, the transmission of data can take place e.g. by means of a TCP/IP interface and/or COBRA interface, an ATM module, an SMS and/or USSD gateway by means of special short messages, for instance SMS (Short Message Services), USSD (Unstructured Supplementary Services Data) messages or other technologies such as MExE (Mobile Execution Environment), via protocols such as GPRS (Generalized Packet Radio Service), WAP (Wireless Application Protocol) or via a user information channel. The user identification of the user 10 of the computing unit 20 can correspond, for instance, to an unambiguous customer address or another user identification for another system, for example an International Mobile Subscriber Identity (IMSI) or an MSISDN (Mobile Subscriber ISDN), which serves the purpose of identification in a mobile radio network, and which user identification is stored for example in the chipcard, for instance an SIM card (Subscriber Identification Module). The user identification can also take place automatically, e.g. by means of calling line identification of the computing unit 20, for example in the case of the mobile radio device. If the hiring or respectively reservation by the user 10 at the central unit 30 by means of the computing unit 20 was successful, an SMS module 33 of the central unit 30 transmits an identification code 411 by means of an SMS and/or USSD data message 41 over a mobile radio network 61 to a mobile radio device 40 of the user 10. The SMS module 33 of the central unit 30 can transmit the identification code 411 e.g. for the first time within a specified time span before begin of the desired use by means of the SMS 41 to the mobile radio device 40 of the user 10. Not only can the user be thereby reminded about the reservation within a sensible time frame before use, but e.g. the risk can also be reduced of the SMS being erased in the meantime by the user e.g. owing to lack of memory capacity on the SIM card of the mobile radio device or by mistake. In addition the central unit 30 can transmit a confirmation of the reservation to the user on the computing unit 20. The MSISDN of the mobile radio device 40 was transmitted by the user 10 either at the reservation, or it was captured and stored already earlier with user-specific data in a way accessible for the central unit 30. If the user 10 has used as the computing unit 20 e.g. the mobile radio device 40, the MSISDN can also be determined, as a special embodiment variant, e.g. by means of calling line identification. The user 10 identifies himself at an identification module by means of the identification code 411 at the predetermined point in time and/or place. The identification module can be achieved through hardware and/or software as part of the onboard system of the vehicle 52/53/54, as network component of the communication network 60, or as a module of the central unit 30. The identification module checks the identification code 411 at the central unit 30, the vehicle 54 being cleared for use upon successful identification of the user 10 via the communication means 57 and the onboard system 55 of the vehicle 52/53/54. The identification module and the SMS/USSD module 33 can be achieved through software and/or hardware. The identification can take place either in that a reply SMS comprising at least the identification code 411 is sent back for confirmation purposes from the mobile radio device 40 over the mobile radio network 61 to the central unit 30. By means of the reply SMS the user 10 is identified by the identification module, and the central unit 30 clears the vehicle 52/53/54 for use for the particular point in time and/or time span and/or place. Or, as another possibility, the identification can also take place in that the user 10 identifies himself by means of the identification code 411 directly at the identification module, each vehicle 52/53/54 of the vehicle reservation system or respectively the respective onboard system 55 of the vehicle 52/53/54 containing a corresponding identification module. In this case, the entry of the identification code 411 at the identification module can take place either manually via input elements of the identification module and/or take place via an infrared interface, for example, or any other interface (e.g. Bluetooth, etc.) between the mobile radio device 40 and the identification module. In many states it is a legal prerequisite that the hiring agent is obligated to check with the hiring customer, i.e. the user 10, as to whether he is in possession of a valid driver's license at the point in time of handover of the vehicle. To achieve a complete automation of the system and/or method according to the invention, the vehicle can be equipped in this case, for instance, with means for picture and sound transmission, such as e.g. a video conferencing system. By means of a built-in document camera or document scanning module, e.g. in combination with OCR (Optical Character Recognition), the validity of the driver's license, in addition to the identification code, can be checked at the central unit 30 via the communication means 60. With modern driver's licenses, where the information is stored on chipcards with memory elements, such as EEPROMs or magnetic strips, only a card reading device is necessary, instead of the document camera and/or document scanning unit, to read the driver's license chipcard in the vehicle. In this embodiment variant, the vehicle 52/53/54 is not cleared for use until after positive check of the identification code 411 and of the validity of the driver's license.

FIG. 2 shows in addition to the vehicle reservation system an embodiment variant in which a user 10 identifies himself at an identification module, the obtained service being billed for automatically by means of a billing module 34 of the central unit 30 via a service provider 70 of a mobile radio network 63. The billing module 34 can likewise be designed through hardware and/or software, and can comprise a memory module for storing data, in particular for adding up services obtained by the user. The billing module 34 can also be achieved partially as part of the mobile radio device 40, such as e.g. in the functions of adding up the obtained service. In this embodiment variant, billing data are calculated by means of the billing module 34, and are transmitted by means of a communication module of the central unit 30 from the central unit 30/34 to a billing module 73, such as e.g. an SAP module, and/or a service provider 70 of a mobile radio network 63. The billing data thereby comprise cost parameters for calculating cost amounts for the services obtained by the user 10 through the hired vehicle 54. The billing data comprise, for example, start and end time or duration of the hiring as well as costs per time unit, etc. The billing can take place e.g. by means of a monetary institution 71 authorised therefor and/or any debiting method 72. This embodiment variant has the advantage, among others, that the costs for the services obtained to the user 10 <sic.> can be billed to the user 10 by the hiring agent without big formalities and high administrative costs.

In addition to the above-mentioned, the central unit 30 can comprise a parking space administration module 35 and a parking space reservation module 36. During the reservation of the vehicle, the user gives indications about his destination or his destinations, which are transmitted by means of the computing unit 20 to the central unit 30. In this case, the SMS 41 can contain indications 413 about one or more free and/or reserved parking spaces at the destination.

Furthermore, it is important to point out that the invention is not limited to a vehicle reservation system but may be used in a general manner for the reservation of capacities and/or capacity units. As an example, vehicle capacity reservation systems may be cited, and such examples will by no means be considered as a limitation of the scope of protection conferred by the invention. In such a computer-supported vehicle capacity reservation system, a user 10 identifies himself at an identification module. The user may indicate for this identification at the central unit 30 for example the MSISDN of the mobile radio device 10 or any other unambiguous identification means. The identification module checks the identification at a central unit 30 (such as described above) and clears for utilisation a capacity unit after a successful identification of the user 10 over the vehicle capacity reservation system. The central unit 30 captures all capacity units of the vehicle capacity reservation system and stores any temporal and/or local availability of the capacity units that may be assigned to a vehicle of a user 10 in a database 31. The user 10 identifies himself at the central unit 30 via the entry elements of a computing unit 20 connected to the central unit 30 and reserves at least one capacity unit for a certain time and/or time span and/or location, at least one capacity unit being indicated as available at the desired time and/or time span and/or location by the central unit 30. An SMS module 33 of the central unit 30 transmits an identification code by means of an SMS 41 to a mobile radio device 40 of the user 10 over a mobile radio network 61. The SMS 41 may also include, in a similar manner as described above, a capacity designation 412 and/or a location 412 and/or a time 412 and/or a time span 412. The user 10 returns a reply SMS that contains at least the identification code 411, as a confirmation to the central unit 30 from the mobile radio device 40 over the mobile radio network 61. The identification module identifies the user 10 based on that reply SMS, and the central unit clears for use at least a capacity unit for the determined time and/or time span and/or location. The technical implementation may be effected in the same manner as already described above. In particular, the SMS module 33 of the central unit 30 may transmit the identification code 411 within a predetermined time span before the beginning of the desired use through the SMS 41 to the mobile radio device 40 of the user 10, or the central unit 30 may transmit a confirmation of the reservation to the computing unit 20 of the user 10. Furthermore, it is possible to compute billing data in a billing module 34 of the central unit 30, and the billing data may be transmitted from the central unit 30, 34 by a communication module of the central unit 30 to a provider 70 of a mobile radio network 63, these billing data comprising cost parameters for calculating the cost amounts of the services obtained by the user 10 for the used capacity. The receipt and/or the use of the at least one capacity unit by the user 10 may also be realised within an access controlled area, the user 10 having to identify himself, when entering this access controlled area, by means of the identification code 411 at an identification module of the access controlled area. It may be useful for certain applications to use the mobile radio device 40 as a calculating unit 20. This calculating unit 20 may communicate with the central unit 20 via one or more computer networks 62, and these one or more computer networks 62 may comprise, for, example, the world-wide backbone network Internet or at least one mobile radio network wherein the calculating unit 20 is able to communicate with the central unit 30 over SMS and/or WAP.

This embodiment variant is particularly suited for the reservation of capacity units of transportation systems and/or bridge systems or, generally, for logistic problems (see FIGS. 3 to 5). The capacity units may comprise, depending on the particular example, load units or transportation units on ships 801, . . . , 805; trains 832, aircraft 831, or trucks 821, 826, 851 . . . , 854, 884, or even abstract units such as tunnel passages 885, air transportation lines 831, etc. There is a great number of application examples. Fir instance, three examples will be given among many others. FIG. 3 shows the ship transfer in transportation routes that comprise water sections (channels or sea portions, etc.), e.g. the connection to islands such as Sicily (Mediterranean sea) or England (the English Channel). The trucks 821, 825 provide the transportation route on land and are coordinated by a central unit 30 at both transportation docks 80/81. The user 10 or, respectively, the truckers 10 of the trucks 821, . . . , 826 may reserve the desired capacity unit (space on board for the trucks 821, . . . , 826 or the goods, waiting places before boarding, etc.) already during their approach to the dock 80/81 via SMS. Regarding the example of the English Channel, the method and the system may also be illustrated for tunnel drives of trains 832 and/or for airplane transportation 831 (FIG. 4) which connect the European continent with the island by means of the docking stations 83/84 by a tunnel and a flight connection. Finally, a last example is mentioned regarding the tunnel travel, for example the crossing of the Gotthard massif. In such systems, the tunnel capacities are often only separately distributed, e.g. for safety reasons or traffic considerations (to avoid traffic jam). Thus, the traffic co-ordination of the north-south connection is a typical application field of this invention. Truckers 881, . . . , 884 (FIG. 5) are able to reserve even hours before their arrival at one of the tunnel docking stations 86/87 a waiting space and/or a tunnel crossing, e.g. via an SMS of a mobile radio device 401, . . . , 406 at the central unit 30 over the mobile radio network 61. The central unit 30 sends an identification code and/or time and/or the money value to be paid and/or the waiting place etc. back to the trucker 881, . . . , 884 concerned. This allows to automate, to control in a simple way and to guarantee the traffic volume, and traffic jams can be avoided in a large area. Furthermore, this method and system may become an important cost factor in the calculation of the transportation costs for transportation companies, and be generally important for the transportation of easily perishable goods.

### List of Reference Numerals

10 user
20 computing unit
30 central unit
31 vehicle fleet administration module
32 vehicle reservation module
33 SMS module
34 billing module
35 parking space administration module
36 parking space reservation module
40 mobile radio device

401 . . . 406 mobile radio device
41 SMS

411 identification code

412 reservation data

413 parking space reservation data
50/51 transfer or respectively receiving point for vehicles
52/53/54 vehicles
55 onboard system
57 communication means
60/61/62/63 communication networks
70 mobile radio service provider
71 monetary institution
72 debiting method
73 SAP module
80 . . . 87 docking stations and/or ports

801 . . . 805 cargo ships and/or freighters

821 . . . 826 trucks

831 aircraft connection

832 train connection

851 . . . 854 trucks

881 . . . 884 trucks

885 tunnel connection

1-41. (canceled)

42. A method for a computer-supported vehicle reservation system in which a user identifies himself/herself at an identification module, the identification module checks the identification with a central unit, and, with successful identification of the user, a vehicle is cleared for use via an onboard system of the vehicle,
wherein the central unit registers all vehicles of the vehicle reservation system, and stores, assigned to the vehicles, in a database temporal and/or local availability of individual of the vehicles,
wherein the user identifies himself/herself at the central unit via input elements of a computing unit connected to the central unit, and reserves a vehicle for a definable time and/or time span and/or location, which vehicle is indicated by the central unit as available for the definable time and/or time span and/or location,
wherein an SMS module of the central unit transmits an identification code to a mobile radio device of the user by an SMS over a mobile radio network, and
wherein a reply SMS from the user, comprising at least the identification code, is sent back by the mobile radio device over the mobile radio network to the central unit as a confirmation, by which reply SMS the user is identified by the identification module, and by the central unit the vehicle is cleared for use via the communication device and onboard system for the defined time and/or time span and location.

43. The method according to claim 42, wherein the central unit checks via the onboard system of the vehicle an operational condition of the vehicle by the SMS before clearance for use.

44. The method according to claim 42, wherein the SMS module of the central unit transmits the identification code by the SMS to the mobile radio device of the user within a predetermined time span before a beginning of desired use.

45. The method according to claim 42, wherein the central unit transmits to the user a confirmation of a reservation on the computing unit.

46. The method according to claim 42, wherein the onboard system checks an operational condition of the vehicle periodically and/or upon request of the central unit, the data of the database of the central unit being updated based on the checked operational condition.

47. The method according to claim 42, wherein billing data is computed by a billing module of the central unit, and is transmitted from the central unit to a service provider of a mobile radio network by a communication module of the central unit, which billing data includes cost parameters for calculating cost amounts for a service procured by the user through the vehicle.

48. The method according to claim 42, wherein the SMS further comprises vehicle designation and/or location and/or time and/or time span.

49. The method according to claim 42, wherein the vehicle is parked in an access-controlled area, and the user identifyies himself/herself at an identification module of the access-controlled area upon entering the access-controlled area by the identification code.

50. The method according to claim 42, wherein the computing unit is the mobile radio device.

51. The method according to claim 42, wherein the computing unit communicates with the central unit via one or more computer networks.

52. The method according to claim 51, wherein the one or more computer networks include the Internet.

53. The method according to claim 51, wherein the user indicates a MSISDN of the mobile radio device for identification at the central unit.

54. The method according to claim 43, wherein the central unit comprises a parking space administration module and a parking space reservation module, whereby during reservation of the vehicle indications about a destination are transmitted to the central unit by the computing unit and/or the SMS contains indications about a reserved parking space at the destination.

55. A computer-supported vehicle registration system, which comprises identification modules for identification of a user at a central unit, in each case an identification module being assigned to a vehicle and, with successful identification, the vehicle being clearable by the central unit for use via an onboard system of the vehicle,
wherein the central unit comprises a memory module, by which all vehicles of the vehicle reservation system are able to be registered, and temporal and/or local availability of individual of the vehicles is storable, assigned to the vehicles,
wherein the central unit comprises an SMS module for transmitting an identification code by an SMS to a mobile radio device of the user via a mobile radio network,
wherein the system comprises a computing unit with communication means for ordering and/or reserving a vehicle for a definable time and/or time span and/or location, the vehicle being indicated by the central unit as available at the definable time and/or time span and/or location,
wherein a user is identifiable by the identification module by an SMS of the mobile radio device, which comprises at least the identification code, and the vehicle is clearable by the central unit for use at the defined time and/or time span and location via the communication means and the onboard system of the vehicle.

56. The computer-supported vehicle registration system according to claim 55, wherein the central unit comprises a billing module by which billing data is transmittable from the central unit to a service provider of a mobile radio network, and which billing data includes cost parameters, based on which cost amounts are calculable for a service procured by the user through the vehicle.

57. The computer-supported vehicle registration system according to claim 55, wherein the SMS further comprises vehicle designation and/or location and/or time and/or time span.

58. The computer-supported vehicle registration system according to claim 55, wherein the system comprises access-controlled areas for parking of the available vehicles, the access-controlled area being accessible to the user by the identification code.

59. The computer-supported vehicle registration system according to claim 55, wherein the mobile radio device further comprises the computing unit.

60. The computer-supported vehicle registration system according to claim 55, wherein the system comprises one or more computer networks, which connect the computing unit to the central unit.

61. The computer-supported vehicle registration system according to claim 60, wherein the one or more computer networks comprise the Internet.

62. The computer-supported vehicle registration system according to claim 60, wherein the identification of the user at the central unit comprises a MSISDN of the mobile radio device.

63. A method for a computer-supported vehicle capacity reservation system in which a user identifies himself/herself at an identification module, the identification module checks the identification with a central unit, and, with successful identification of the user, a capacity unit is cleared for use via the vehicle capacity reservation system,
wherein the central unit registers all capacity units of the vehicle capacity reservation system and stores, assignable to a vehicle of the user, in a database temporal and/or local availability of the capacity units,
wherein the user identifies himself/herself at the central unit via input elements of a computing unit connected to the central unit, and reserves at least one capacity unit for a definable time and/or time span and/or location, which at least one capacity unit is indicated by the central unit as available for the definable time and/or time span and/or location,
wherein an SMS module of the central unit transmits an identification code to a mobile radio device of the user by an SMS over a mobile radio network, and
wherein a reply SMS from the user, comprising at least the identification code, is sent back by the mobile radio device over the mobile radio network to the central unit as a confirmation, by which reply SMS the user is identified by the identification module, and by which central unit the at least one capacity unit is cleared for use for the defined time and/or time span and location under access control to the at least one capacity unit.

64. The method according to claim 63, wherein the SMS module of the central unit transmits the identification code by the SMS to the mobile radio device of the user within a predetermined time span before beginning of a desired use.

65. The method according to claim 63, wherein the central unit transmits to the user a confirmation of the reservation on the computing unit.

66. The method according to claim 63, wherein billing data is computed by a billing module of the central unit, and is transmitted from the central unit to a service provider of a mobile radio network by a communication module of the central unit, which billing data includes cost parameters for calculating cost amounts for a service procured by the user through used capacity.

67. The method according to claim 63, wherein the SMS further comprises capacity designation and/or location and/or time and/or time span.

68. The method according to claim 63, wherein the at least one capacity unit is accessible or usable in an access-controlled area, the user identifying himself/herself at an identification module of the access-controlled area upon entering the access-controlled area by the identification code.

69. The method according to claim 63, wherein the mobile radio device is used as a computing unit.

70. The method according to claim 63, wherein the computing unit communicates with the central unit via one or more computer networks.

71. The method according to claim 70, wherein the one or more computer networks include the Internet.

72. The method according to claim 70, wherein the one or more computer networks include a mobile radio network and the computing unit communicates with the central unit by SMS and/or WAP.

73. The method according to claim 70, wherein the user indicates a MSISDN of the mobile radio device for identification at the central unit.

74. A computer-supported vehicle capacity reservation system, which comprises identification modules for identification of a user at a central unit, a capacity unit being clearable to the user for use by a central unit with successful identification via the vehicle capacity reservation system,
wherein the central unit comprises a memory module, by which all capacity units of the vehicle capacity reservation system are able to be registered, and temporal and/or local availability of the individual capacity units is storable, assigned to a vehicle of the user,
wherein the central unit comprises an SMS module for transmitting an identification code by an SMS to a mobile radio device of the user via a mobile radio network,
wherein the system comprises a computing unit with communication means for ordering and/or reserving at least one capacity unit for a definable time and/or time span and/or location, the at least one capacity unit being indicated by the central unit as available at the definable time and/or time span and/or location,
wherein the user is identifiable by the identification module by an SMS of the mobile radio device, which comprises at least the identification code, and the at least one capacity unit is clearable by the central unit for use at the defined time and/or time span and location via a clearance system under access control to the at least one capacity unit.

75. The computer-supported vehicle capacity reservation system according to claim 74, wherein the central unit comprises a billing module by which billing data is transmittable from the central unit to a service provider of a mobile radio network, and which billing data includes cost parameters, based on which cost amounts are calculable for the service procured by the user through the at least one capacity unit.

76. The computer-supported vehicle capacity reservation system according to claim 74, wherein the SMS further comprises capacity designation and/or location and/or time and/or time span.

77. The computer-supported vehicle capacity reservation system according to claim 74, wherein the system comprises access-controlled areas for parking of the available vehicles, the access-controlled area being accessible to the user by the identification code.

78. The computer-supported vehicle capacity reservation system according to claim 74, wherein the mobile radio device further comprises the computing unit.

79. The computer-supported vehicle capacity reservation system according to claim 74, wherein the system comprises one or more computer networks, which connect the computing unit to the central unit.

80. The computer-supported vehicle capacity reservation system according to claim 74, wherein the one or more computer networks comprise the Internet.

81. The computer-supported vehicle capacity reservation system according to claim 79, wherein the one or more computer networks include a mobile radio network and the computing unit and the central unit comprise an SMS module and/or a WAP module.

82. The computer-supported vehicle capacity reservation system according to any claim 79, wherein the identification of the user at the central unit comprises a MSISDN of the mobile radio device.
